(19) United States
(12) Patent Application Publication
(10) Pub. No.: US 2009/0136758 A1
(43) Pub. Date: May 28, 2009

(54) NON-MUTUALLY-ADHESIVE PELLET, PROCESS FOR PRODUCING NON-MUTUALLY-ADHESIVE PELLET, AND PROCESS FOR PRODUCING RUBBER MOLDING

(75) Inventor: Takeshi Minaba, Chiba (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/065,026

(22) PCT Filed: Jul. 5, 2006
(86) PCT No.: PCT/JP2006/313810

§ 371 Date: Feb. 27, 2008

(30) Foreign Application Priority Data
Sep. 1, 2005 (JP) 2005-253212
Sep. 30, 2005 (JP) 2005-286843

(51) Int. Cl. B32B 25/08; B32B 5/20

(52) U.S. Cl. 428/407; 156/244.19; 156/244.24; 156/78

(57) ABSTRACT

A non-mutually-adhesive pellet, process for producing non-mutually-adhesive pellet, and process for producing rubber molding are provided. The non-mutually-adhesive pellet comprises a core containing a rubber composition comprising a rubber, reinforcement and softener and a coating layer which contains a thermoplastic polymer and with which the core is coated, wherein the thermoplastic polymer has the crystal melting peak temperature as measured by a DSC measuring method including the specified procedures and the Vicat softening temperature as measured in accordance with JIS K7206 at a load of 10 N and a heating rate of 50° C./h is over 40° C.

### TECHNICAL FIELD

The present invention relates to a non-mutually-adhesive pellet, a process for producing non-mutually-adhesive pellet, a process for producing a vulcanized rubber molding, and a process for producing a vulcanized sponge rubber molding.

### BACKGROUND ART

US2005/0146075A1 discloses a process for producing non-mutually-adhesive pellets, having a step of deforming a sticky polymer coated with a thermoplastic polymer under heat and pressure, and a step of cutting the resultant deformed material.

Non-mutually-adhesive pellets obtained by this production process, however, have a problem that in the case of molding a mixture obtained by mixing the pellets and a vulcanizing agent and vulcanizing the resultant molding to produce a vulcanized rubber molding, if the crystal melting peak temperature of the above-described thermoplastic polymer is too higher than the temperature of the mixing (this temperature is set at a temperature lower than a temperature at which the above-described vulcanizing agent reacts), then, the thermoplastic polymer is not dispersed successfully in the above-described mixture, and consequently, the resultant vulcanized rubber molding does not have a good surface. Adversely, if mixing is performed at a temperature higher than the crystal melting peak temperature of a thermoplastic polymer, for obtaining a mixture containing a successfully dispersed thermoplastic polymer, there occurs a problem that a vulcanizing agent reacts during mixing and the resultant mixture shows increased viscosity (undesirable phenomenon called scorch).

Further, non-mutually-adhesive pellets obtained by the above-described production process have also a problem that they are deformed by pressure applied on the pellets during filling and preservation thereof in a vessel, and consequently, the pellets mutually form aggregates, and the aggregates are not separated into individual non-mutually-adhesive pellets only by tender pushing by fingers.

### DISCLOSURE OF THE INVENTION

The present invention has an object of providing non-mutually-adhesive pellets which scarcely form an aggregate during filling and preservation thereof in a vessel and in a mixture thereof with a vulcanizing agent, a thermoplastic polymer (thermoplastic polymer contained in non-mutually-adhesive pellets) is dispersed successfully; a process for producing non-mutually-adhesive pellets; a process for producing a vulcanize rubber molding; and a process for producing a vulcanized sponge rubber molding.

The present inventors have intensively investigated for attaining the above-described object, and resultantly found that the above-described object is accomplished by using a thermoplastic polymer having a crystal melting peak temperature of lower than 90° C. and a Vicat softening temperature of higher than 40° C., leading to completion of the present invention.

That is, the present invention provides a non-mutually-adhesive pellet comprising a core containing a rubber composition comprising a rubber, reinforcement and softener and a coating layer which contains a thermoplastic polymer and with which the core is coated, wherein the thermoplastic polymer satisfies the following conditions (1) and (2):

(1) the crystal melting peak temperature as measured by a DSC measuring method including the following procedures is lower than 90° C.

(1-1) maintaining at 150° C. for 2 minutes,

(1-2) cooling from 150° C. to 20° C. at a rate of 5° C./min,

(1-3) maintaining at 20° C. for 2 minutes,

(1-4) heating from 20° C. to 150° C. at a rate of 5° C./min, and the temperature at a melting peak observed in this procedure is defined as the crystal melting peak temperature;

(2) the Vicat softening temperature as measured in accordance with JIS K7206 at a load of 10 N and a heating rate of 50° C./h is over 40° C.

The present invention provides a process for producing a non-mutually-adhesive pellet, comprising the following steps of

(I) molding a rubber composition comprising a rubber, reinforcement and softener by an extruder having a die for sheet molding or by a calendar roll, to obtain a sheet;

(II) pasting a film composed of a thermoplastic polymer satisfying the above-described conditions (1) and (2), on both surfaces of the sheet, to obtain a laminated sheet;

and

(III) cutting the laminated sheet.

This production process is hereinafter referred to as production process-1.

The present invention provides a process for producing a non-mutually-adhesive pellet, comprising the following steps of

(I) molding a rubber composition comprising a rubber, reinforcement and softener and a thermoplastic polymer satisfying the above-described conditions (1) and (2), by a multi-layer extrusion molding method, to obtain a laminated sheet having a core composed of the rubber composition and a coating layer composed of the thermoplastic polymer;

and

(II) cutting the laminated sheet.

This production process is hereinafter referred to as production process-2.

Also, the present invention provides a process for producing a vulcanized rubber molding, comprising the following steps of

(I) mixing the above-described non-mutually-adhesive pellet or a non-mutually-adhesive pellet obtained by the above-described production process, and at least a vulcanizing agent, to obtain a mixture;

(II) molding the mixture, to obtain a molding;

and

(III) vulcanizing the molding.

This production process is hereinafter referred to as production process-3.

Further, the present invention provides a process for producing a vulcanized sponge rubber molding, comprising the following steps of

(I) mixing the above-described non-mutually-adhesive pellet or a non-mutually-adhesive pellet obtained by the above-described production process, and at least a vulcanizing agent and a foaming agent, to obtain a mixture;

(II) molding the mixture, to obtain a molding;

and

(III) vulcanizing and foaming the molding.

This production process is hereinafter referred to as production process-4.

### BRIEF EXPLANATION OF DRAWINGS

FIG. 1 shows an apparatus example for producing non-mutually-adhesive pellets of the present invention.

FIG. 2 shows a pellet production apparatus used in an example.

### DESCRIPTION OF MARKS

1: laminated sheet
2: supporting roll
3: heater
4: delivery roll
5: embossing roll
6: cutting roll
7: anvil roll
8: pellet catcher
9: non-mutually-adhesive pellet
10: air cylinder
11: cutting blade
12: laminated sheet
13: punching table
14: sponge

### BEST MODES FOR CARRYING OUT THE INVENTION

As the rubber in the present invention, there can be exemplified ethylene-α-olefin-nonconjugated diene copolymerized rubbers; natural rubbers; styrene rubbers such as styrene-butadiene rubber, styrene-butadiene-styrene block copolymer (SBS), styrene-ethylene-butylene-styrene block copolymer (SEBS) obtained by hydrogenation of SBS, styrene-isoprene-styrene block copolymer (SIS), and styrene-ethylene-propylene-styrene block copolymer (SEPS) obtained by hydrogenation of SIS; polyisobutylene rubber; butyl rubber; butadiene rubber; isoprene rubber; nitrile rubber; fluorine rubber; vinyl pyridine rubber; silicone rubber; butadiene-methyl methacrylate rubber; acrylic rubbers; and urethane rubbers; and combinations of two or more of these rubbers. Of them, ethylene-α-olefin-nonconjugated diene copolymerized rubbers showing excellent weather resistance are particularly preferable.

The ethylene-α-olefin-nonconjugated diene copolymerized rubber means a copolymerized rubber composed of an ethylene unit, an α-olefin unit having 3 or more carbon atoms, and a nonconjugated diene unit having 5 or more carbon atoms. “Unit” in the term such as “ethylene unit” means a unit of a polymerized monomer. The content of each monomer unit in the ethylene-α-olefin-nonconjugated diene copolymerized rubber may be advantageously determined according to a desired physical property of a vulcanized rubber molding or a vulcanized sponge rubber molding in the present invention. As the α-olefin, there can be exemplified propylene, 1-butene, 1-pentene, 1-hexene, 4-methyl-1-pentene, 1-octene and 1-decene; and combinations of two or more of them. Of them, propylene or 1-butene is preferable. As the nonconjugated diene, there can be exemplified dicyclopentadiene, ethylidene norbornene and 1,4-hexadiene; and combinations of two or more of them.

As the ethylene-α-olefin-nonconjugated diene copolymerized rubber, there can be exemplified an ethylene-propylene-ethylidene norbornene copolymerized rubber, ethylene-propylene-dicyclopentadiene copolymerized rubber and ethylene-propylene-ethylidene norbornene-dicyclopentadiene copolymerized rubber; and combinations of two or more of them.

The ethylene-α-olefin-nonconjugated diene copolymerized rubber can be produced by known polymerization methods (for example, a slurry polymerization method, solution polymerization method, mass polymerization method and gas phase polymerization method) using known olefin polymerization catalysts (for example, Ziegler-Natta catalysts, and complex catalysts such as metallocene complexes and non-metallocene complexes).

As the reinforcement in the present invention, there can be exemplified inorganic fillers such as calcium carbonate, talc, mica, silica and carbon black; reinforcing short fibers such as aramid fiber, nylon fiber, wood pulp fiber, carbon fiber and glass fiber; and combinations of two or more of them. Of them, carbon blacks showing a high reinforcing effect are particularly preferable. As the carbon black, there can be exemplified SRF (N770), GPF (N660), FEF (N550), HAF (N330), ISAF (N220), SAF (N110), FT (N880) and MT (N990), usually used in the field of rubber. Of them, carbon blacks having an average particle size of 50 nm or more are preferable. When the average particle size is less than 50 nm, poor dispersion of carbon black in a rubber composition in the present invention tends to occur, and consequently, which exerts a reverse influence, in some cases, on an extrusion property of a rubber composition in the present invention, or on a kneading property of a non-mutually-adhesive pellet and a vulcanizing agent in the present invention. The use amount of the reinforcement is usually 10 to 200 parts by weight per 100 parts by weight of rubber. When the use amount is less than 10 parts by weight, a sufficient reinforcing effect is not obtained.

As the softener in the present invention, there can be exemplified process oil, lubricating oil, paraffin, liquid paraffin, petroleum asphalt, vaseline, coal tar pitch, castor oil, linseed oil, rubber substitute, beeswax, ricinoleic acid, palmitic acid, barium stearate, calcium stearate, zinc laurate, atactic polypropylene and cumarone indene resin. Of them, process oil is particularly preferable. As the process oil, there can be exemplified paraffinic oils, naphthenic oils and aromatic oils. The use amount of the softener is usually 1 to 200 parts by weight, preferably less than 150 parts by weight, particularly preferably 100 parts by weight or less, per 100 parts by weight of rubber. The use amount over 200 parts by weight is not preferable from the standpoint of stress relation and Mooney viscosity described later of a rubber composition. In the case of use, as the rubber, of an oil extended rubber combined with a softener such as a process oil, the amount of a softener contained in the oil extended rubber is construed to be included in the use amount of a softener as described above.

The rubber, reinforcement and softener constituting a rubber composition in the present invention may each be combined with components such as processing auxiliaries such as zinc oxide, stearic acid, metal soap, fatty ester, fatty amide and paraffin wax; antioxidants such as phenol-type antioxidants, imidazole-type antioxidants and phosphorus-based antioxidants; flame retardants such as magnesium hydroxide, antimony trioxide and halogen compounds; tackifiers; or coupling agents for reinforcement.

The thermoplastic polymer in the present invention satisfies the following conditions (1) and (2):

(1) the crystal melting peak temperature as measured by a DSC measuring method including the following procedures is lower than 90° C., preferably lower than 70° C.

(1-1) maintaining at 150° C. for 2 minutes,

(1-2) cooling from 150° C. to 20° C. at a rate of 5° C./min,

(1-3) maintaining at 20° C. for 2 minutes,

(1-4) heating from 20° C. to 150° C. at a rate of 5° C./min, and the temperature at a melting peak observed in this procedure is defined as the crystal melting peak temperature;

(2) the Vicat softening temperature as measured in accordance with JIS K7206 at a load of 10 N and a heating rate of 50° C./h is over 40° C.

The condition (1) is a condition for successful dispersion of a thermoplastic polymer in a kneaded material of a non-mutually-adhesive pellet with an additive such as a vulcanizing agent, and the condition (2) is a condition for suppressing formation of an aggregate of a non-mutually-adhesive pellet, which may occurs during filling and preservation thereof in a vessel.

As the thermoplastic polymer, there can be exemplified crystalline polyolefin, polystyrene, nylon, polyester, polymethyl methacrylate, polyvinyl alcohol, polycarbonate, polyvinyl chloride and polyvinylidene chloride. Of them, crystalline polyolefin is preferable from the standpoint of easy availability and easiness of processing into pellet.

The crystalline polyolefin means a crystalline thermoplastic polymer obtained by homopolymerization or copolymerization of an olefin having 2 to 20 carbon atoms (that is, crystalline thermoplastic polymer containing the olefin unit). As the crystalline polyolefin, there can be exemplified a homopolymer of propylene; propylene-ethylene copolymer; propylene-butene-1 copolymer; propylene-ethylene-butene-1 copolymer; low density polyethylene; middle density polyethylene; high density polyethylene; ethylene-α-olefin copolymers such as an ethylene-butene-1 copolymer, ethylene-4-methylpentene-1 copolymer, ethylene-hexene-1 copolymer, ethylene-octene-1 copolymer and ethylene-decene-1 copolymer; ethylene-methacrylate copolymers such as an ethylene-methyl methacrylate copolymer; ethylene-acrylate copolymers such as an ethylene-methyl acrylate copolymer; and copolymers with ethylene such as an ethylene-vinyl acetate copolymer and saponified substances of this copolymer. These crystalline polyolefins may also be polymers modified with α,β-unsaturated carboxylic acids (for example, acrylic acid and methacrylic acid), alicyclic carboxylic acids (for example, stearic acid) or maleic anhydride; or derivatives of these acids (for example, methyl methacrylate and sodium acrylate). Of them, particularly preferable are ethylene-α-olefin copolymers obtained by polymerization of ethylene and an α-olefin in the presence of a polymerization catalyst having a uniform active site such as a metallocene complex.

The crystalline polyolefin can be produced by known polymerization methods (for example, a slurry polymerization method, solution polymerization method, mass polymerization method and gas phase polymerization method) using known olefin polymerization catalysts (for example, Ziegler-Natta catalysts, and complex catalysts having a uniform active site such as metallocene complexes and non-metallocene complexes), or by known polymerization methods (for example, mass polymerization method and solution polymerization method) using known radical initiators.

The thermoplastic polymer in the present invention may also be combined with an inorganic filler such as calcium carbonate, talc, mica and carbon black; or an additive such as a flame retardant, ultraviolet absorber, antistatic agent, pigment, nucleating agent, antifogging agent and flame retardant.

The rubber composition in the present invention can be produced by mixing components such as a rubber, reinforcement and softener by a sealed-type mixing machine such as Banbury mixer, or an extruder such as a single screw extruder, co-rotation twin screw extruder, counter-rotation twin screw extruder, and twin screw extruder equipped with a multi-stage mixing area. Of them, particularly preferable is a screw extruder capable of carrying out production of a rubber composition and molding of a sheet composed of the rubber composition.

The stress relaxation of a rubber composition in the present invention is preferably larger than 0.090, further preferably 0.135 or more, from the standpoint of suppression of formation of an aggregate of a non-mutually-adhesive pellet. When the stress relaxation is 0.090 or less, non-mutually-adhesive pellets tend to be deformed during filling and preservation thereof in a vessel, and consequently, an aggregate tends to be formed.

As a process for producing a rubber composition having a stress relaxation over 0.090, there can be exemplified (1) a production process in which the compounding proportion of a reinforcement and/or softener is adjusted, in the case of a rubber composition having identical rubber kind and compounding proportion, and (2) a production process in which a rubber having high stress relation is selected, or a rubber having Mooney viscosity appropriately adjusted is used, in the case of a rubber composition having identical compounding proportion of a reinforcement and a softener per 100 parts by weight of rubber.

The Mooney viscosity ML₁₊₄ (100° C.) of a rubber composition in the present invention is preferably 36 or more, from the standpoint of suppression of formation of an aggregate of a non-mutually-adhesive pellet since a rubber composition having high Mooney viscosity generally shows large stress relation. As a process for producing a rubber composition having a Mooney viscosity ML₁₊₄ (100° C.) of 36 or more, there can be exemplified (1) a production process in which the compounding proportion of a reinforcement and/or softener is adjusted, in the case of a rubber composition having identical rubber kind and compounding proportion, and (2) a production process in which a rubber having high Mooney viscosity is selected, or a rubber having Mooney viscosity appropriately adjusted is used, in the case of a rubber composition having identical compounding proportion of a reinforcement and a softener per 100 parts by weight of rubber.

As the vulcanization agent in the present invention, there can be exemplified sulfur and organic peroxides. As the organic peroxide, there can be exemplified dicumyl peroxide, 2,5-dimethyl-2,5-di(tertiary butyl peroxy)hexane, 2,5-dimethyl-2,5-di(benzoyl peroxy)hexane, 2,5-dimethyl-2,5-(tertiary butyl peroxy)hexyne-3, di-tertiary butyl peroxide, di-tertiary butyl peroxide-3, 3,5-trimethylcyclohexane, and tertiary butyl hydroperoxide. Of them, dicumyl peroxide, di-tertiary butyl peroxide, and di-tertiary butyl peroxide-3,3,5-trimethylcyclohexane are particularly preferable. The use amount of a vulcanizing agent is usually 0.1 to 10 parts by weight, preferably 0.2 to 8 parts by weight based on 100 parts by weight of rubber.

The vulcanizing agent may be combined with a vulcanization accelerator. As the vulcanization accelerator, there can be exemplified tetramethylthiuram monosulfide, tetramethylthiuram disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfeneamide, N-oxydiethylene-2-benzothiazole-sulfeneamide, N,N-diisopropyl-2-benzothiazolesulfeneamide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, diorthotolylguanidine, orthotolyl-bi-guanide, diphenylguanidine-phthalate, acetaldehyde-aniline reaction product, butylaldehyde-aniline condensate, hexamethylenetetramine, acetaldehyde ammonia, 2-mercaptoimidazoline, thiocarbalinide, diethylthiourea, dibutylthiourea, trimethylthiourea, diorthotolylthiourea, zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc bidutylxanthogenate and ethylenethiourea; and combinations of two or more of them. The use amount of the vulcanization accelerator is usually 0.05 to 20 parts by weight, preferably 0.1 to 8 parts by weight based on 100 parts by weight of rubber.

As the forming agent in the present invention, there can be exemplified sodium bicarbonate, sodium carbonate, ammonium bicarbonate, ammonium carbonate, ammonium nitrite, N,N′-dimethyl-N,N′-dinitroso-terephthalamide, N,N′-dinitroso-pentamethylene-tetramine, azodicarboneamide, azobisisobutyronitrile, azocyclohexylnitrile, azodiaminobenzene, barium azodicarboxylate, benzene-sulfonyl-hydrazide, toluene-sulfonyl-hydrazide, toluene-sulfonyl-hydrazide derivative, p-toluene-sulfonyl-semicarbazide, 4,4′-oxybis(benzenesulfonyl hydrazide), diphenylsulfone-3,3′-disulfonyl-hydrazide, calcium azide, 4,4′-diphenyl-disulfonyl azide-para-toluene-sulfonyl azide, p-toluenesulfonylacetone hydrazone and hydrazodicarboneamide; and combinations of two or more of them. Of them, 4,4′-oxybis(benzenesulfonyl hydrazide) is preferable from the standpoint of obtaining stable foaming magnification. The use amount of the foaming agent is usually 0.5 to 20 parts by weight per 100 parts by weight of rubber.

As the die for sheet molding in the step (I) of the production process-1, there can be exemplified a slit-shaped die and a circular-shaped die.

As the production method of a film composed of a thermoplastic polymer in the step (II) of the production process-1, there can be exemplified known methods such as a T die method and an inflation method. The thickness of the film is generally about 1 to 500 μm, preferably about 5 to 300 μm, particularly preferably about 10 to 100 μm. The film may also be a drawn film such as a mono-axially drawn film or bi-axially drawn film (for example, sequential bi-axially drawn film and simultaneous bi-axially drawn film), produced by known methods such as a tenter drawing method and a tubular drawing method. The film may also be a multi-layer film produced by methods such as a co-extrusion method and a lamination method.

As the production method of a laminated sheet in the step (II) of the production process-1, there can be exemplified a method of pasting a film composed of a thermoplastic polymer on both surfaces of a sheet molded by an extruder having a die for sheet molding, and a method of continuously pasting a film composed of a thermoplastic polymer on both surfaces of a sheet of a rubber composition molded continuously by calendar rolls composed of at least two heating rolls. In the latter method, the size of the heating roll is not particularly restricted, and the length of the roll plane and the diameter of the roll can be arbitrarily selected. The surface of the heating roll may be mirror-like finished or coarsely finished surface. The distance between surfaces of the heating rolls may be appropriately adjusted according to the thickness of a sheet. The temperature of the heating roll is preferably about 30° C. to 150° C., more preferably about 40° C. to 100° C. When the production amount of a film per unit time is large, there can be exemplified a method of using a heating roll of large diameter, a method of using at least three heating rolls, and a method of supplying a previously heated rubber composition, as methods for dissolving heating deficiency.

The thickness of the laminated sheet in the step (II) of the production process-1 is preferably about 0.5 mm to 10 mm, more preferably about 0.8 mm to 5 mm.

The laminated sheet containing a rubber composition as a core, and a thermoplastic polymer as a coating layer in the step (I) of the production process-2 can be produced by a multi-layer extrusion molding machine having a slit-shaped die or circular-shaped die. A multi-layer extrusion molding method is particularly preferable since production of a rubber composition and production of a laminated sheet can be carried out continuously by a multi-layer extrusion molding machine. The thickness of the coating layer is usually about 1 to 500 μm, preferably about 5 to 300 μm, more preferably about 10 to 100 μm. The thickness of the laminated sheet is preferably about 0.5 mm to 10 mm, more preferably about 0.8 mm to 5 mm.

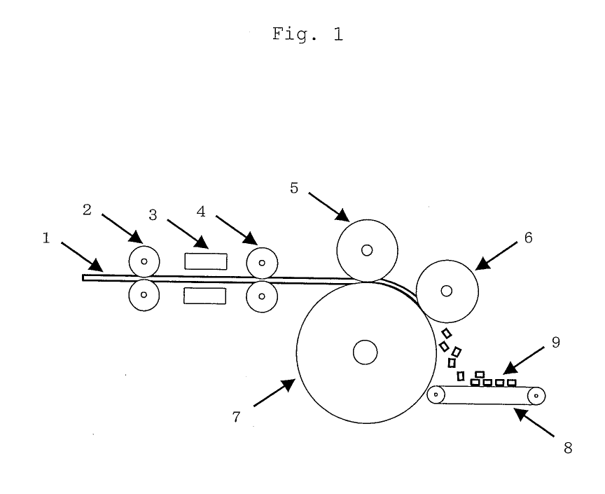

The step (III) of the production process-1 and the step (II) of the production process-2, that is, the step of cutting a laminated sheet to obtain non-mutually-adhesive pellets will be illustrated below referring to FIG. 1 showing an apparatus example for producing non-mutually-adhesive pellets of the present invention.

Non-mutually-adhesive pellets can be produced by heating a laminated sheet at about 30 to 150° C., pressing a site to be cut of the heated laminated sheet to deform the site, then, cutting this site. When the laminated sheet is produced by an extrusion molding method as in the production process-2, the temperature of the laminated sheet directly after production is usually about 30 to 150° C., thus, it may be advantageous that a site to be cut of the laminated sheet directly after production is pressed to deform, then, cut. As a method of heating a laminated sheet of lower than 30° C. up to temperatures of about 30 to 150° C., there can be exemplified a method of passing a laminated sheet between heating rolls, and a method of heating a laminated sheet 1 by heaters 3 placed above and below thereof as exemplified in FIG. 1.

As the method of pressing the heated laminated sheet to deform, and cutting this, there can be exemplified (1) a method in which pressing and deformation and cutting are carried out using the same cutting blade, and (2) a method in which pressing and deformation and cutting are carried out using separate cutting blades. The method (1) is a method in which a site to be cut is pressed gradually by a cutting blade and the cutting blade is pushed in a laminated sheet, then, pressing is further progressed to perform cutting. Since a film composed of a thermoplastic polymer is drawn by the pushing-in, the film approximates another film composed of a thermoplastic polymer. The reduction ratio in the thickness of a laminated sheet by the pushing-in is preferably about 10 to 30% when the original thickness is 100%. The cut surface is almost coated with a film composed of a thermoplastic polymer, and the proportion of cut surface manifesting exposure of a rubber composition is only slight. Unless the pushing-in is carried out gradually, that is, if a laminated sheet is cut at one stroke with high pressure, the laminated sheet is cut before desirable deformation, leading to insufficient coating of the cut surface with a film composed of a thermoplastic polymer. Conversely, when the pushing-in is carried out too slowly, coating of the cut surface with a film composed of a thermoplastic polymer becomes insufficient. Therefore, the pushing-in is carried out preferably under pressure by which films composed of a thermoplastic polymer approximate mutually. Pushing by a cutting blade may be pushing by which a laminated sheet is continuously and gradually deformed, then, cut (one-stage method), or pushing by which first, a laminated sheet is gradually deformed, then, the laminated sheet is cut (two-stage method). The extent and speed of pressing may be advantageously determined by effecting a previous test depending on the kind of the laminated sheet.

The above-described method (2) is a method as exemplified in FIG. 1. The laminated sheet 1 is heated by heaters 3 and passes through delivery rolls 4, then, carried onto an anvil roll 7, and its site to be cut is deformed by pressing by an embossing roll 5 having an embossing blade on its surface. The deformed site of the laminated sheet is cut by a cutting roll 6 having a cutting blade on its surface, and thus molded non-mutually-adhesive pellets 9 falls on a pellet catcher 8 composed of a conveyer and collected.

Though the shape and size of the non-mutually-adhesive pellet of the present invention are not particularly restricted, it is preferable that the pellet has upper and lower coated layers of approximate rectangle shape, the thickness from the upper surface to the lower surface is preferably about 0.5 mm to 10 mm, more preferably about 0.8 mm to 5 mm, and the length of one side of the rectangle is about 2 mm to 10 mm, from the standpoint of supplying non-mutually-adhesive pellets to a molding apparatus quantitatively.

For improving a mutual non-mutually-adhesive property of non-mutually-adhesive pellets produced, an inorganic fine powder or an organic fine powder may be dusted or a liquid anti-blocking agent may be applied, in an amount sufficient to improve non-mutually-adhesive property, on the surface of non-mutually-adhesive pellets. The dusted fine powder or applied anti-blocking agent on parts not coated with a coating layer containing a thermoplastic polymer of the non-mutually-adhesive pellets contributes to improvement in non-mutually-adhesive property. As the fine powder, there can be exemplified fine powders of calcium carbonate, barium sulfate, silica, talc, calcium stearate or polyolefins. As the liquid anti-blocking agent, there can be exemplified nonionic surfactants and, New Aid DF-30 (trade name) manufactured by Seiko Chemical Co., Ltd. which is an emulsion of a synthetic wax and a long chain fatty acid salt.

Mixings in the step (I) of the production process-3 and in the step (I) of the production process-4 are each carried out for a time to attain sufficient mixing using a usual mixing machine such as a roll and a kneader, usually at temperatures lower than 90° C., at which a crosslinking reaction with a vulcanizing agent does not progress easily.

As methods for molding in the step (II) of the production process-3 and in the step (II) of the production process-4, there can be exemplified a heat press molding method, injection molding method, compression molding method and extrusion molding method.

The step (III) of the production process-3 and the step (III) of the production process-4 are steps in which a molding obtained in the step (II) thereof is heated usually at 120° C. or higher, preferably at 140° C. to 240° C. for about 1 to 60 minutes using a vulcanization apparatus such as a hot air vulcanization apparatus and a high frequency vulcanization apparatus.

The above-described extrusion molding method is a preferable method since the above-described step (I) (mixing), step (II) (molding) and step (III) (vulcanization, or, vulcanization and foaming) can be carried out continuously by connecting an extrusion molding machine and the above-described vulcanization apparatus.

The vulcanized rubber molding and vulcanized sponge rubber molding in the present invention are used particularly preferably in car parts such as glass channels, door seal sponges and weather strips; or building material parts such as gaskets.

### EXAMPLES

The present invention will be described further in detail by examples, but the present invention is not limited the them.

### Example 1

100 parts by weight of a non-oil-extended ethylene-propylene-ethylidenenorbornene-dicyclopentadiene copolymerized rubber having a trade name of Esprene with a grade name of 5527F manufactured by Sumitomo Chemical Co., Ltd., having an ethylene unit content of 54.0 wt %, a propylene unit content of 37.5 wt % and a total content of an ethylidenenorbornene unit and a dicyclopentadiene unit of 8.5 wt % (the sum of all monomer unit contents is 100 wt %) and having a Mooney viscosity ML₁₊₄ (125° C.) as measured in accordance with JIS K6300 using a L type rotor at 125° C. of 130, as a rubber, 100 parts by weight of carbon black (reinforcement) having a trade name of Carbon Black Asahi 50 HG manufactured by Asahi Carbon Co., Ltd. and having an average particle size of 85 nm, 30 parts by weight of calcium carbonate (reinforcement) having a trade name of Whiton (howaiton) SSB manufactured by Shiraishi Calcium Kaisha, Ltd., 80 parts by weight of paraffin process oil (softener) having a trade name of PS430 manufactured by Idemitsu Kosan Co., Ltd., 7 parts by weight of zinc oxide (process additive), 1 part by weight of stearic acid (process additive) and 2 parts by weight of process additive having a trade name of Struktol WB16 manufactured by Struktol Co. Ltd. were kneaded for 5 minutes using a Banbury mixer having an inner volume of 1.5 liter at a rotor revolution of 60 rpm, to obtain a rubber composition.

This rubber composition was molded using a press molding machine heated at 105° C., to manufacture a sheet of 150 mm×150 mm×3 mm thickness.

This sheet was sandwiched on both surfaces thereof by films having a thickness of 40 μm made of a linear low density polyethylene (thermoplastic polymer) having a density of 880 kg/m³ obtained by copolymerization of ethylene and 1-hexene with a metallocene complex, the polyethylene having a trade name of Excellen FX with a grade name of CX4002, being manufactured by Sumitomo Chemical Co., Ltd, and having a crystal melting peak temperature of 68° C. and a Vicat softening temperature as measured in accordance with JIS K7206 at a load of 10 N and a heating rate of 50° C./h of 47° C., and the sheet and films were pasted using a press molding machine heated at 110° C., to obtain a laminated sheet.

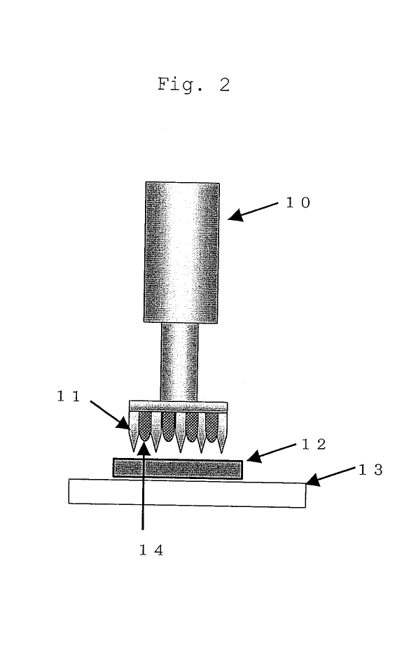

The laminated sheet was punched using a pellet production apparatus shown in FIG. 2 (first punching), and the punched laminated sheet was rotated by 90 degree on the same plane and further punched (second punching), to obtain non-mutually-adhesive pellets in the form of rectangular solid having size of 10 mm×10 mm×3 mm (thickness). The punching was performed by pushing linear seamless (namely, straight continuous) cutting blades arranged from the front side of the drawing toward the back side thereof to the laminated sheet 12 placed on a punching table 13 by an air cylinder 10. A sponge 14 is placed continuously from the front side of the drawing toward the back side thereof, for preventing sandwiching of the sheet or pellet between the cutting blades 11.

The non-mutually-adhesive pellets were dipped in a 7×diluted aqueous solution of a liquid anti-blocking agent (an emulsion of a synthetic wax and a long chain fatty acid salt) having a trade name of New Aid DF-30 manufactured by Seiko Chemical Co., Ltd., to obtain non-mutually-adhesive pellets coated with the anti-blocking agent. The aggregating property of the non-mutually-adhesive pellets was “excellent”.

100 parts by weight of the non-mutually-adhesive pellets coated with the anti-blocking agent, 2 parts by weight of calcium oxide (dehydrating agent), 0.7 parts by weight of sulfur (vulcanizing agent), 0.875 parts by weight of 4,4′-dithiodimorpholine (vulcanization accelerator) having a trade name of Noc Master R80E manufactured by Ouchi Shinko Chemical Industrial Co., Ltd., 2.5 parts by weight of 2-mercaptobenzothiazole (vulcanization accelerator) having a trade name of Renogran MBT80 manufactured by Beyer sha, 0.4 parts by weight of tellurium diethyldithiocarbamate (vulcanization accelerator) having a trade name of Renogran TDEC75 manufactured by Beyer sha, 0.625 parts by weight of zinc di-n-butyldithiocarbamate (vulcanization accelerator) having a trade name of Renogran ZDBC80 manufactured by Beyer sha, 1.875 parts by weight of zinc dimethyldithiocarbamate (vulcanization accelerator) having a trade name of Renogran ZDMC80 manufactured by Beyer sha, and 3 parts by weight of Neocelbon N1000S (foaming agent) containing 4,4-oxybis (benzenesulfonyl hydrazide) as a main component were mixed by open rolls heated at 70° C., to obtain a mixture. The mixture had a Mooney viscosity ML₁₊₄ (100° C.) as measured in accordance with JIS K6300 using a L type rotor at 100° C. of 45.

The mixture was extruded by a 45 mm extruder equipped with a tubular dice having an internal diameter of 10 mm and having a wall thickness of 1.2 mm under a dice temperature of 80° C. and a cylinder temperature of 60° C., to obtain a tubular molding.

The molding was heated in a hot air vulcanization apparatus of 220° C. for 10 minutes, to obtain a tubular vulcanized sponge rubber molding. The sponge rubber molding had a density as measured by an underwater substitution method (method A) using a wire as a pending jig in accordance with JIS K6268 of 0.56 g/cm³, and the (visual) appearance thereof was excellent without projections. The results are shown in Table 1.

The above-described crystal melting peak temperature was measured by a method including the following procedures using a differential scanning calorimeter (input-compensated DSC) having a trade name of DSC220C manufactured by Seiko Denshi Kogyo K.K.:

(1) maintaining about 8 mg of the thermoplastic polymer at 150° C. for 2 minutes,

(2) cooling from 150° C. to 20° C. at a rate of 5° C./min,

(3) maintaining at 20° C. for 2 minutes,

(4) heating from 20° C. to 150° C. at a rate of 5° C./min, and the temperature at a melting peak observed in this procedure is defined as the crystal melting peak temperature.

The above-mentioned aggregating property of the non-mutually-adhesive pellets was evaluated by a method including the following procedures:

(1) placing 100 g of the non-mutually-adhesive pellets into a 500 mL Teflon (registered trade name) beaker;

(2) a weight of 2 kg is placed thereon;

(3) it is left in an atmosphere of 40° C. for 24 hours;

(4) the weight is removed;

(5) the aggregating property when non-mutually-adhesive pellets to be discharged from a declined beaker are not aggregated at all is designated as “excellent”, the aggregating property when the discharged non-mutually-adhesive pellets are slightly aggregated is designated as “good”, the aggregating property when the discharged non-mutually-adhesive pellets form aggregates and when the aggregates are separated into individual non-mutually-adhesive pellets only by slight pushing with fingers is designated as “permissible”, and when the aggregates are not separated into individual non-mutually-adhesive pellets without strong pushing on the aggregates with fingers is designated as “poor”.

### Comparative Example 1

The same procedure as in Example 1 was carried out excepting that the thermoplastic polymer was changed to a long chain branched low density polyethylene having a density of 919 kg/m³ obtained by polymerization of ethylene by a high pressure polymerization method, the polyethylene having a trade name of Sumikacene with a grade name of G202, being manufactured by Sumitomo Chemical Co., Ltd, and having a crystal melting peak temperature of 107° C. and a Vicat softening temperature of 91° C., to obtain non-mutually-adhesive pellets coated with an anti-blocking agent. The aggregating property of the non-mutually-adhesive pellets was “excellent”.

The same procedure as in Example 1 was carried out excepting that the non-mutually-adhesive pellet was changed to this non-mutually-adhesive pellet, and the heating temperature of the open rolls was changed from 70° C. to 110° C., to obtain a mixture. The mixture had a Mooney viscosity ML₁₊₄ (100° C.) of 97.

The procedure in Example 1 was carried out using this mixture, to obtain a tubular vulcanized sponge rubber molding. The sponge rubber molding had a density of 0.88 g/cm³, and the (visual) appearance thereof was excellent without projections. The results are shown in Table 1.

### Comparative Example 2

The same procedure as in Example 1 was carried out excepting that the thermoplastic polymer was changed to a long chain branched low density polyethylene having a trade name of Sumikacene with a grade name of G202 manufactured by Sumitomo Chemical Co., Ltd, and having a crystal melting peak temperature of 107° C. and a Vicat softening temperature of 91° C., to obtain non-mutually-adhesive pellets coated with an anti-blocking agent.

The same procedure as in Example 1 was carried out excepting that the non-mutually-adhesive pellet was changed to this non-mutually-adhesive pellet, to obtain a mixture. The mixture had a Mooney viscosity ML₁₊₄ (100° C.) of 48.

The procedure in Example 1 was carried out using this mixture, to obtain a tubular vulcanized sponge rubber molding. The sponge rubber molding had a density of 0.58 g/cm³, and the (visual) appearance thereof was poor with projections. The results are shown in Table 1.

### Comparative Example 3

The same procedure as in Example 1 was carried out excepting that the thermoplastic polymer was changed to a linear low density polyethylene having a density of 870 kg/m³ obtained by copolymerization of ethylene and 1-butene with a metallocene complex, the polyethylene having a trade name of Excellen FX with a grade name of CX5505, being manufactured by Sumitomo Chemical Co., Ltd, and having a crystal melting peak temperature of 58° C. and a Vicat softening temperature of 28° C., to obtain non-mutually-adhesive pellets coated with an anti-blocking agent. The aggregating property of the non-mutually-adhesive pellets was “permissible”.

The same procedure as in Example 1 was carried out excepting that the non-mutually-adhesive pellet was changed to this non-mutually-adhesive pellet, and the heating temperature of the open rolls was changed from 70° C. to 60° C., to obtain a mixture. The mixture had a Mooney viscosity ML₁₊₄ (100° C.) of 43.

The procedure in Example 1 was carried out using this mixture, to obtain a tubular vulcanized sponge rubber molding. The sponge rubber molding had a density of 0.54 g/cm³ and the (visual) appearance thereof was excellent without projections. The results are shown in Table 1.

### Comparative Example 4

The same procedure as in Example 1 was carried out excepting that a film of a thermoplastic polymer, and an anti-blocking agent were not used, to obtain pellets made of a rubber composition. The aggregating property of the pellets was “poor”.

The same procedure as in Example 1 was carried out excepting that the non-mutually-adhesive pellet was changed to this pellet, and the heating temperature of the open rolls was changed from 70° C. to 40° C., to obtain a mixture. The mixture had a Mooney viscosity ML₁₊₄ (100° C.) of 44.

The procedure in Example 1 was carried out using this mixture, to obtain a tubular vulcanized sponge rubber molding. The sponge rubber molding had a density of 0.54 g/cm³, and the (visual) appearance thereof was excellent without projections. The results are shown in Table 1.

TABLE 1

| | Example | Comparative Example | | | |
|---|---|---|---|---|---|
| | 1 | 1 | 2 | 3 | 4 |
| Grade of rubber | 5527F | 5527F | 5527F | 5527F | 5527F |
| Thermoplastic | | | | | |
| polymer | | | | | |
| Grade | CX4002 | G202 | G202 | X5505 | — |
| Crystal melting | 68 | 107 | 107 | 58 | — |
| peak temperature | | | | | |
| (° C.) | | | | | |
| Vicat softening | 47 | 91 | 91 | 28 | — |
| temperature (° C.) | | | | | |
| Aggregating | Excel- | Excel- | Excel- | Permis- | poor |
| property of pellet | lent | lent | lent | sible | |
| Production of | | | | | |
| mixture using pellet | | | | | |
| Mixing temperature | 70 | 110 | 70 | 60 | 40 |
| (° C.) | | | | | |
| Mooney viscosity | 45 | 97 | 48 | 43 | 44 |
| (100° C.) of mixture | | | | | |
| Sponge rubber | | | | | |
| molding | | | | | |
| Density (g/cm³) | 0.56 | 0.88 | 0.58 | 0.54 | 0.54 |
| Appearance | Excel- | Excel- | poor | Excel- | Excel- |
| | lent | lent | | lent | lent |

The following matters are understood from Table 1:

(1) In Example 1 using a thermoplastic polymer having a crystal melting peak temperature of lower than 90° C. (68° C.) and a Vicat softening temperature of over 40° C. (47° C.) and in which the heating temperature of the open rolls was a temperature (70° C.) at which a crosslinking reaction with a vulcanizing agent does not progress easily, the aggregating property of the pellets was “excellent”, the Mooney viscosity ML₁₊₄ (100° C.) of the mixture did not increase (45), and the (visual) appearance of the sponge rubber molding was excellent without projections;

(2) In Comparative Example 1 using a thermoplastic polymer having a crystal melting peak temperature of not lower than 90° C. (107° C.) and in which the heating temperature of the open rolls was a temperature (110° C.) at which a crosslinking reaction with a vulcanizing agent progresses easily, the Mooney viscosity ML₁₊₄ (100° C.) of the mixture increased;

(3) In Comparative Example 2 using a thermoplastic polymer having a crystal melting peak temperature of not lower than 90° C. (107° C.) and in which the heating temperature of the open rolls was a temperature (70° C.) at which a crosslinking reaction with a vulcanizing agent does not progress easily, the (visual) appearance of the sponge rubber molding was poor with projections;

(4) In Comparative Example 3 using a thermoplastic polymer having a Vicat softening temperature of not over 40° C. (28° C.), the aggregating property of the pellets was “permissible”.

(5) In Comparative Example 4 using no thermoplastic polymer, the aggregating property of the pellets was “poor”.

### Example 2

100 parts by weight of a non-oil-extended ethylene-propylene-ethylidenenorbornene-dicyclopentadiene copolymerized rubber having a trade name of Esprene with a grade name of 5527F manufactured by Sumitomo Chemical Co., Ltd., having an ethylene unit content of 54.0 wt %, a propylene unit content of 37.5 wt % and a total content of an ethylidenenorbornene unit and a dicyclopentadiene unit of 8.5 wt % (the sum of all monomer unit contents is 100 wt %) and having a Mooney viscosity ML₁₊₄ (125° C.) of 130, as a rubber, 100 parts by weight of carbon black (reinforcement) having a trade name of Carbon Black Asahi 50 HG manufactured by Asahi Carbon Co., Ltd. and having an average particle size of 85 nm, 80 parts by weight of paraffin process oil (softener) having a trade name of PS430 manufactured by Idemitsu Kosan Co., Ltd., 30 parts by weight of calcium carbonate (reinforcement) having a trade name of Whiton (howaiton) SSB manufactured by Shiraishi Calcium Kaisha, Ltd., 7 parts by weight of zinc oxide (process additive), 1 part by weight of stearic acid (process additive) and 2 parts by weight of processing auxiliary having a trade name of Struktol WB16 manufactured by Struktol sha were kneaded for 5 minutes using a Banbury mixer having an inner volume of 1.5 liter at a rotor revolution of 60 rpm, to obtain a rubber composition. This composition had a Mooney viscosity ML₁₊₄ (100° C.) of 45 and a stress relaxation of 0.150.

This rubber composition was molded using a press molding machine heated at 105° C., to manufacture a sheet of 150 mm×150 mm×3 mm thickness.

This sheet was sandwiched on both surfaces thereof by films having a thickness of 40 μm made of a linear low density polyethylene (thermoplastic polymer) having a trade name of Excellen FX with a grade name of CX4002 manufactured by Sumitomo Chemical Co., Ltd, and having a crystal melting peak temperature of 68° C. and a Vicat softening temperature of 47° C., and the sheet and films were pasted using a press molding machine heated at 110° C., to obtain a laminated sheet.

The laminated sheet was processed in the same manner as in Example 1, to obtain non-mutually-adhesive pellets in the form of rectangular solid having size of 10 mm×10 mm×3 mm.

The non-mutually-adhesive pellets were dipped in a 7× diluted aqueous solution of a liquid anti-blocking agent having a trade name of New Aid DF-30 manufactured by Seiko Chemical Co., Ltd., to obtain non-mutually-adhesive pellets coated with the anti-blocking agent. The aggregating property of the non-mutually-adhesive pellets was “excellent”. The results are shown in Table 2.

The above-described stress relaxation of the rubber composition was measured by a method including the following procedures using a full automatic four-point bending stress relaxation meter (manufactured Island Industry K.K.) at a compression strain of 20% and a measuring temperature of 40° C.

(1) the rubber composition was molded by a pressing machine heated at 100° C., to manufacture a sheet having a thickness of 4 mmt;

(2) from this sheet, 8 mmφ test specimens were manufactured using a punching machine;

(3) the test specimen was set on a stress relaxation meter, and the test specimen was warm up to a measuring temperature of 40° C., then, compressed at a compression strain of 20%, and the stress relaxation is calculated according to the following formula.

Stress relaxation=load (N) 100 seconds after endowment with compression deformation/load (N) 0.01 second after endowment with compression deformation

### Example 3

The same procedure as in Example 2 was carried out excepting that the amount of carbon black (reinforcement) was changed to 85 parts by weight and the amount of paraffin process oil (softener) was changed to 65 parts by weight. The rubber composition had a Mooney viscosity ML₁₊₄ (100° C.) of 53 and a stress relaxation of 0.135. The aggregating property of the non-mutually-adhesive pellets coated with an anti-blocking agent was “excellent”. The results are shown in Table 2.

### Example 4

Ethylene, propylene, ethylidenenorbornene and dicyclopentadiene were solution-polymerized in a continuous polymerization vessel controlled at 43 to 47° C. using hexane as a solvent and using a Ziegler-Natta catalyst obtained by a combination of VOCl₃ and ethyl aluminum sesqui-chloride (EASC), to synthesize an ethylene-propylene-ethylidenenorbornene-dicyclopentadiene copolymerized rubber (called “rubber A”) having an ethylene unit content of 54.0 wt %, a propylene unit content of 36.6 wt % and a total content of an ethylidenenorbornene unit and a dicyclopentadiene unit of 9.4 wt % (the sum of all monomer unit contents is 100 wt %) and having a Mooney viscosity ML₁₊₄ (125° C.) of 59.

The same procedure as in Example 2 was carried out excepting that the rubber was changed to rubber A and the amount of paraffin process oil (softener) was changed to 75 parts by weight. The rubber composition had a Mooney viscosity ML₁₊₄ (100° C.) of 45 and a stress relaxation of 0.094. The aggregating property of the non-mutually-adhesive pellets coated with an anti-blocking agent was “good”. The results are shown in Table 2.

### Comparative Example 5

The same procedure as in Example 2 was carried out excepting that the amount of paraffin process oil (softener) was changed to 120 parts by weight. The rubber composition had a Mooney viscosity ML₁₊₄ (100° C.) of 25 and a stress relaxation of 0.090. The aggregating property of the non-mutually-adhesive pellets coated with an anti-blocking agent was “permissible”. The results are shown in Table 2.

### Comparative Example 6

The same procedure as in Example 2 was carried out excepting that the amount of paraffin process oil (softener) was changed to 140 parts by weight. The rubber composition had a Mooney viscosity ML₁₊₄ (100° C.) of 17 and a stress relaxation of 0.056. The aggregating property of the non-mutually-adhesive pellets coated with an anti-blocking agent was “poor”. The results are shown in Table 2.

TABLE 2

| | | | | Comparative | |
|---|---|---|---|---|---|
| | Example | | | Example | |
| | 2 | 3 | 4 | 5 | 6 |
| Compounding | | | | | |
| (parts by weight) | | | | | |
| Rubber | | | | | |
| 5527F | 100 | 100 | | 100 | 100 |
| Rubber A | | | 100 | | |
| Reinforcement | | | | | |
| Carbon black | 100 | 85 | 100 | 100 | 100 |
| Calcium carbonate | 30 | 30 | 30 | 30 | 30 |
| Softener | | | | | |
| Paraffin process | 80 | 65 | 75 | 120 | 140 |
| oil | | | | | |
| Processing aid | | | | | |
| Zinc oxide | 7 | 7 | 7 | 7 | 7 |
| Stearic acid | 1 | 1 | 1 | 1 | 1 |
| Struktol WB16 | 2 | 2 | 2 | 2 | 2 |
| Rubber composition | | | | | |
| Mooney viscosity | 45 | 53 | 45 | 25 | 17 |
| (100° C.) | | | | | |
| Stress relaxation | 0.150 | 0.135 | 0.094 | 0.090 | 0.056 |
| Aggregating property | Excel- | Excel- | Good | Permis- | Poor |
| of pellet | lent | lent | | sible | |

It is understood from Example 2, Example 3, Comparative Example 5 and Comparative Example 6 in Table 2 that even if the kinds of rubber and the compounding proportions are identical (Esprene 5527F, 100 parts by weight), the stress relaxation value of the resultant rubber composition can be changed by varying the compounding proportion of a reinforcement and/or softener, and the stress relaxation value can be controlled larger than 0.090 by appropriately selecting the compounding proportion.

### Comparative Example 7

The same procedure as in Example 2 was carried out excepting that 100 parts by weight of Esprene 5527F was changed to a combination of 75 parts by weight of Esprene 5527F with 25 parts by weight of an ethylene-propylene-ethylidenenorbornene copolymerized rubber having a trade name of Esprene with a grade name of 5214 manufactured by Sumitomo Chemical Co., Ltd., having an ethylene unit content of 51.0 wt %, a propylene unit content of 37.8 wt % and an ethylidenenorbornene unit content of 11.2 wt % (the sum of all monomer unit contents is 100 wt %) and having a Mooney viscosity ML₁₊₄ (100° C.) of 35, and a blend rubber obtained by blending this combination by open rolls of 80° C. and other components were kneaded. The blend rubber had a Mooney viscosity ML₁₊₄ (121° C.) of 75, and the resultant rubber composition had a Mooney viscosity ML₁₊₄ (100° C.) of 36 and a stress relaxation of 0.084, and the aggregating property of the non-mutually-adhesive pellets was “permissible”. The results are shown in Table 3.

### Comparative Example 8

The same procedure as in Example 2 was carried out excepting that 100 parts by weight of Esprene 5527F was changed to a combination of 50 parts by weight of Esprene 5527F with 50 parts by weight of Esprene 5214, and a blend rubber obtained by blending this combination by open rolls of 80° C. and other components were kneaded. The blend rubber had a Mooney viscosity ML₁₊₄ (121° C.) of 55, and the resultant rubber composition had a Mooney viscosity ML₁₊₄ (100° C.) of 30 and a stress relaxation of 0.054, and the aggregating property of the non-mutually-adhesive pellets was “permissible”. The results are shown in Table 3.

### Comparative Example 9

The same procedure as in Example 2 was carried out excepting that 100 parts by weight of Esprene 5527F was changed to a combination of 25 parts by weight of Esprene 5527F with 75 parts by weight of Esprene 5214, and a blend rubber obtained by blending this combination by open rolls of 80° C. and other components were kneaded. The blend rubber had a Mooney viscosity ML₁₊₄ (121° C.) of 38, and the resultant rubber composition had a Mooney viscosity ML₁₊₄ (100° C.) of 25 and a stress relaxation of 0.037, and the aggregating property of the non-mutually-adhesive pellets was “poor”. The results are shown in Table 3.

### Comparative Example 10

The same procedure as in Example 2 was carried out excepting that 100 parts by weight of Esprene 5527F was changed to 100 parts by weight of Esprene 5214 (Mooney viscosity ML₁₊₄ (121° C.) is 26). The resultant rubber composition had a Mooney viscosity ML₁₊₄ (100° C.) of 20 and a stress relaxation of 0.019, and the aggregating property of the non-mutually-adhesive pellets was “poor”. The results are shown in Table 3.

TABLE 3

| | Example | Comparative Example | | | |
|---|---|---|---|---|---|
| | 2 | 7 | 8 | 9 | 10 |
| Compounding | | | | | |
| (parts by weight) | | | | | |
| Rubber | | | | | |
| 5527F | 100 | 75 | 50 | 25 | |
| 5214 | | 25 | 50 | 75 | 100 |
| Reinforcement | | | | | |
| Carbon black | 100 | 100 | 100 | 100 | |
| Calcium carbonate | 30 | 30 | 30 | 30 | |
| Softener | | | | | |
| Paraffin process | 80 | 80 | 80 | 80 | |
| oil | | | | | |
| Processing aid | | | | | |
| Zinc oxide | 7 | 7 | 7 | 7 | |
| Stearic acid | 1 | 1 | 1 | 1 | |
| Struktol WB16 | 2 | 2 | 2 | 2 | |
| Mooney viscosity | — | 75 | 55 | 38 | — |
| (121° C.) of blend | | | | | |
| rubber | | | | | |
| Rubber composition | | | | | |
| Mooney viscosity | 45 | 36 | 30 | 25 | 20 |
| (100° C.) | | | | | |
| Stress relaxation | 0.150 | 0.084 | 0.054 | 0.037 | 0.019 |
| Aggregating | Excel- | Permis- | Permis- | Poor | Poor |
| property of pellet | lent | sible | sible | | |

It is understood from Table 3 that even if the compounding proportions of components other than rubber such as a reinforcement and a softener per 100 parts by weight of rubber are identical, the stress relaxation value of the resultant rubber composition can be larger than 0.090 by using a blend rubber having appropriately adjusted Mooney viscosity as the rubber, and consequently, non-mutually-adhesive pellets scarcely causing aggregation can be obtained.

### Example 5

A combination of 17.6 parts by weight of an ethylene-propylene-ethylidenenorbornene copolymerized rubber having a trade name of Esprene with a grade name of 505 manufactured by Sumitomo Chemical Co., Ltd., having an ethylene unit content of 50.0 wt %, a propylene unit content of 40.1 wt % and an ethylidenenorbornene unit content of 9.9 wt % (the sum of all monomer unit contents is 100 wt %) and having a Mooney viscosity ML₁₊₄ (125° C.) of 59 with 82.4 parts by weight of an ethylene-propylene-ethylidenenorbornene copolymerized rubber extended with an extending oil (this oil-extended copolymerized rubber is composed of 50 parts by weight of an oil-extended oil and 50 parts by weight of the copolymerized rubber) having a trade name of Esprene with a grade name of 600F manufactured by Sumitomo Chemical Co., Ltd., having an ethylene unit content of 66.0 wt %, a propylene unit content of 30.0 wt % and an ethylidenenorbornene unit content of 4.0 wt % (the sum of all monomer unit contents is 100 wt %) and having a Mooney viscosity ML₁₊₄ (100° C.) of 63, as a rubber, 80 parts by weight of carbon black (reinforcement) having a trade name of Carbon Black Asahi 60 G manufactured by Asahi Carbon Co., Ltd. and having an average particle size of 45 nm, 110 parts by weight of paraffin process oil (softener) having a trade name of PW-380 manufactured by Idemitsu Kosan Co., Ltd., 5 parts by weight of zinc oxide (process additive), and 1 part by weight of stearic acid (process additive) were treated in the same manner as in Example 2.

The resultant rubber composition had a Mooney viscosity ML₁₊₄ (100° C.) of 21 and a stress relaxation of 0.111. The aggregating property of the non-mutually-adhesive pellets coated with an anti-blocking agent was “good”. The results are shown in Table 4.

### Example 6

The same procedure as in Example 5 was carried out excepting that 82.4 parts by weight of Esprene 600F was changed to 82.4 parts by weight of an ethylene-propylene-ethylidenenorbornene copolymerized rubber extended with an extending oil (this oil-extended copolymerized rubber is composed of 28.6 parts by weight of an oil-extended oil and 71.4 parts by weight of the copolymerized rubber) having a trade name of Esprene with a grade name of 600F manufactured by Sumitomo Chemical Co., Ltd., having an ethylene unit content of 61 wt %, a propylene unit content of 33.1 wt % and an ethylidenenorbornene unit content of 5.9 wt % (the sum of all monomer unit contents is 100 wt %) and having a Mooney viscosity ML₁₊₄ (125° C.) of 82 (composed of 58.8 parts by weight of the copolymerized rubber and 23.6 parts by weight of an extending oil).

The resultant rubber composition had a Mooney viscosity ML₁₊₄ (100° C.) of 36 and a stress relaxation of 0.095. The aggregating property of the non-mutually-adhesive pellets coated with an anti-blocking agent was “good”. The results are shown in Table 4.

TABLE 4

| | Example 5 | Example 6 |
|---|---|---|
| Compounding (parts by weight) | | |
| Rubber | | |
| 505 | 17.6 | 17.6 |
| 600F | 82.4 | |
| 606F | | 82.4 |
| Reinforcement | | |
| Carbon black | 80 | 80 |
| Softener | | |
| Paraffin process oil | 110 | 110 |
| Processing aid | | |
| Zinc oxide | 5 | 5 |
| Stearic acid | 1 | 2 |
| Rubber composition | | |
| Mooney viscosity (100° C.) | 21 | 36 |
| Stress relaxation | 0.111 | 0.095 |
| Aggregating property of pellet | Good | Good |

It is understood from Table 4 that even if the Mooney viscosity of the rubber composition is low, the stress relaxation of the resultant rubber composition can be larger than 0.090 by appropriately selecting the rubber to be used, and consequently, non-mutually-adhesive pellets scarcely causing aggregation can be obtained.

### INDUSTRIAL APPLICABILITY

According to the present invention, non-mutually-adhesive pellets are provided which scarcely form an aggregate during filling and preservation thereof in a vessel, and in a mixture with a vulcanizing agent, a thermoplastic polymer is dispersed successfully. According to the present invention, a process for producing non-mutually-adhesive pellets is provided. Further, according to the present invention, a process for producing a vulcanized rubber molding and a process for producing a vulcanized sponge rubber molding, using non-mutually-adhesive pellets, are provided.

1. A non-mutually-adhesive pellet comprising a core containing a rubber composition comprising a rubber, reinforcement and softener and a coating layer which contains a thermoplastic polymer and with which the core is coated, wherein the thermoplastic polymer satisfies the following conditions (1) and (2):
(1) the crystal melting peak temperature as measured by a DSC measuring method including the following procedures is lower than 90° C.
(1-1) maintaining at 150° C. for 2 minutes,
(1-2) cooling from 150° C. to 20° C. at a rate of 5° C./min,
(1-3) maintaining at 20° C. for 2 minutes,
(1-4) heating from 20° C. to 150° C. at a rate of 5° C./min, and the temperature at a melting peak observed in this procedure is defined as the crystal melting peak temperature;
(2) the Vicat softening temperature as measured in accordance with JIS K7206 at a load of 10 N and a heating rate of 50° C./h is over 40° C.

2. The non-mutually-adhesive pellet according to claim 1, wherein the rubber composition is a rubber composition comprising 100 parts by weight of a rubber, 10 to 200 parts by weight of a reinforcement and 1 to 200 parts by weight of a softener.

3. The non-mutually-adhesive pellet according to claim 1, wherein the rubber is an ethylene-α-olefin-nonconjugated diene copolymerized rubber.

4. The non-mutually-adhesive pellet according to claim 1, wherein the thermoplastic polymer is an ethylene-α-olefin copolymer obtained by polymerizing ethylene and an α-olefin in the presence of a catalyst having a uniform active site.

5. The non-mutually-adhesive pellet according to claim 1, wherein the rubber composition has a stress relaxation of over 0.090.

6. The non-mutually-adhesive pellet according to claim 1, wherein the rubber composition has a Mooney viscosity ML1+4 (100° C.) of 36 or more.

7. A process for producing a non-mutually-adhesive pellet, comprising the following steps of
(I) molding a rubber composition comprising a rubber, reinforcement and softener by an extruder having a die for sheet molding or by a calendar roll, to obtain a sheet;
(II) pasting a film composed of a thermoplastic polymer satisfying the following conditions (1) and (2), on both surfaces of the sheet, to obtain a laminated sheet;
(1) the crystal melting peak temperature as measured by a DSC measuring method including the following procedures is lower than 90° C.
(1-1) maintaining at 150° C. for 2 minutes,
(1-2) cooling from 150° C. to 20° C. at a rate of 5° C./min,
(1-3) maintaining at 20° C. for 2 minutes,
(1-4) heating from 20° C. to 150° C. at a rate of 5° C./min, and the temperature at a melting peak observed in this procedure is defined as the crystal-melting-peak temperature;
(2) the Vicat softening temperature as measured in accordance with JIS K7206 at a load of 10 N and a heating rate of 50° C./h is over 40° C., and
(III) cutting the laminated sheet.

8. The process according to claim 7, wherein the rubber composition is a rubber composition comprising 100 parts by weight of a rubber, 10 to 200 parts by weight of a reinforcement and 1 to 200 parts by weight of a softener.

9. The process according to claim 7, wherein the rubber is an ethylene-α-olefin-nonconjugated diene copolymerized rubber.

10. The process according to claim 7, wherein the thermoplastic polymer is an ethylene-α-olefin copolymer obtained by polymerizing ethylene and an α-olefin in the presence of a catalyst having a uniform active site.

11. The process according to claim 7, wherein the rubber composition has a stress relaxation of over 0.090.

12. The process according to claim 7, wherein the rubber composition has a Mooney viscosity ML₁₊₄ (100° C.) of 36 or more.

13. A process for producing a non-mutually-adhesive pellet, comprising the following steps of
(I) molding a rubber composition comprising a rubber, reinforcement and softener and a thermoplastic polymer satisfying the following conditions (1) and (2), by a multi-layer extrusion molding method, to obtain a laminated sheet having a core composed of the rubber composition and a coating layer composed of the thermoplastic polymer;
(1) the crystal melting peak temperature as measured by a DSC measuring method including the following procedures is lower than 90° C.
(1-1) maintaining at 150° C. for 2 minutes,
(1-2) cooling from 150° C. to 20° C. at a rate of 5° C./min,
(1-3) maintaining at 20° C. for 2 minutes,
(1-4) heating from 20° C. to 150° C. at a rate of 5° C./min, and the temperature at a melting peak observed in this procedure is defined as the crystal melting peak temperature;
(2) the Vicat softening temperature as measured in accordance with JIS K7206 at a load of 10 N and a heating rate of 50° C./h is over 40° C., and
(II) cutting the laminated sheet.

14. The process according to claim 13, wherein the rubber composition is a rubber composition comprising 100 parts by weight of a rubber, 10 to 200 parts by weight of a reinforcement and 1 to 200 parts by weight of a softener.

15. The process according to claim 13, wherein the rubber is an ethylene-α-olefin-nonconjugated diene copolymerized rubber.

16. The process according to claim 13, wherein the thermoplastic polymer is an ethylene-α-olefin copolymer obtained by polymerizing ethylene and an α-olefin in the presence of a catalyst having a uniform active site.

17. The process according to claim 13, wherein the rubber composition has a stress relaxation of over 0.090.

18. The process according to claim 13, wherein the rubber composition has a Mooney viscosity ML₁₊₄ (100° C.) of 36 or more.

19. A process for producing a vulcanized rubber molding, comprising the following steps of
(I) mixing the non-mutually-adhesive pellet as described in claim 1, and at least a vulcanizing agent, to obtain a mixture;
(II) molding the mixture, to obtain a molding;
and
(III) vulcanizing the molding.

20. The process according to claim 19, wherein mixing of the step (I) is carried out by an extruder.

21. A process for producing a vulcanized sponge rubber molding, comprising the following steps of
(I) mixing the non-mutually-adhesive pellet as described in claim 1, and at least a vulcanizing agent and a foaming agent, to obtain a mixture;
(II) molding the mixture, to obtain a molding;
and
(III) vulcanizing and foaming the molding.

22. The process according to claim 21, wherein mixing of the step (I) is carried out by an extruder.

23. A process for producing a vulcanized rubber molding, comprising the following steps of
(I) mixing a non-mutually-adhesive pellet obtained by the production process as described in claim 7, and at least a vulcanizing agent, to obtain a mixture;
(II) molding the mixture, to obtain a molding;
and
(III) vulcanizing the molding.

24. A process for producing a vulcanized sponge rubber molding, comprising the following steps of
(I) mixing a non-mutually-adhesive pellet obtained by the production process as described in claim 7, and at least a vulcanizing agent and a foaming agent, to obtain a mixture;
(II) molding the mixture, to obtain a molding;
and
(III) vulcanizing and foaming the molding.
